(19) United States
(12) Patent Application Publication
(10) Pub. No.: US 2021/0390738 A1
(43) Pub. Date: Dec. 16, 2021

(54) METHODS AND APPARATUS TO CLUSTER AND COLLECT HEAD-TOE LINES FOR AUTOMATIC CAMERA CALIBRATION

(71) Applicant: NEC Corporation, Minato-ku, Tokyo (JP)

(72) Inventors: Arun Kumar CHANDRAN, Singapore (SG); Yusuke TAKAHASHI, Singapore (SG)

(73) Assignee: NEC Corporation, Minato-ku, Tokyo (JP)

(21) Appl. No.: 17/287,006

(22) PCT Filed: Aug. 16, 2019
(86) PCT No.: PCT/JP2019/032163

§ 371 Date: Apr. 20, 2021

(30) Foreign Application Priority Data
Oct. 29, 2018 (SG) 10201809572R

(51) Int. Cl. G06T 7/80; G06K 9/62; G06K 9/00; H04N 17/00; G06K 9/46

(52) U.S. Cl. CPC G06T 7/80; G06K 9/6218; G06T 2207/30196; H04N 17/002; G06K 9/4604; G06K 9/00362

(57) ABSTRACT

An automatic method improves calibration of the camera by detecting key body points on people in images (100); extracting, from the key body points, orthogonal lines that extend from a head to feet of the people (110); selecting, from the orthogonal lines, head-toe lines of the people who are standing upright in the images (120); and calibrating the camera from the head-toe lines of the people who are standing upright in the images (130).

### TECHNICAL FIELD

The present invention generally relates to methods and apparatus that calibrate a camera.

### BACKGROUND ART

Camera calibration is a necessary step for accurate video and image based analyses. If a camera is not accurately calibrated then such analyses cannot be performed without errors. For example, some of the applications that benefit from camera calibration include reducing false positives in object detection and reducing errors in detecting physical measurements (e.g., size) based on pixel measurements.

### SUMMARY OF INVENTION

### Solution to Problem

Example embodiments include methods and apparatus that calibrate a camera. A method improves calibration of the camera by detecting key body points on people in images; extracting, from the key body points, orthogonal lines that extend from a head to feet of the people; selecting, from the orthogonal lines, head-toe lines of the people who are standing upright in the images; and calibrating the camera from the head-toe lines of the people who are standing upright in the images.

### BRIEF DESCRIPTION OF DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with example embodiments.

FIG. 1 is a method to calibrate a camera from people in images in accordance with an example embodiment.

FIG. 2 is a method to determine a posture of a person in an image in accordance with an example embodiment.

FIG. 3A shows a front and back side view of a human with key body points in accordance with an example embodiment.

FIG. 3B shows a front view of a human with lines connecting key body points in accordance with an example embodiment.

FIG. 4 is a flow diagram for calibrating a camera based on analysis of images of people in accordance with an example embodiment.

FIG. 5 is an electronic device for executing example embodiments in accordance with an example embodiment.

Skilled artisans will appreciate that elements in the figures are illustrated for simplicity and clarity and have not necessarily been depicted to scale.

### DESCRIPTION OF EMBODIMENTS

The following detailed description is merely exemplary in nature and is not intended to limit example embodiments or their uses. Furthermore, there is no intention to be bound by any theory presented in the preceding background or the following detailed description. It is the intent of the present embodiments to present unique methods and apparatus to improve camera calibration.

Camera calibration (also known as geometric camera calibration and camera re-sectioning) estimates parameters of a lens and image sensor of a camera. Once these parameters are known, important tasks can be accurately performed, such as correcting for lens distortion, measuring the size of an object, determining a location of the camera in its environment, etc. Furthermore, these tasks are used in wide variety of applications, such as machine vision, detecting objects, measuring a size of objects, navigation (e.g., robotic navigation systems), three dimensional (3D) scene reconstruction, and many others.

Accurately calibrating a camera, however, is a tedious process that poses numerous technical challenges. For example, conventional camera calibration involves physically measuring or determining intrinsic camera parameters (e.g., focal length and principal point), extrinsic camera parameters (e.g., pan, tilt, and roll angle that represent rotation and translation of the camera), and distortion coefficients. Measuring and recording these parameters are both time consuming and prone to human error.

Example embodiments solve these problems and provide methods and apparatus that efficiently and accurately calibrate a camera.

An example embodiment estimates the parameters of the camera by determining vanishing points from images using parallel lines of objects in the images. By way of example, these objects can include one or more of humans, automobiles, or other objects and structures with known sizes and shapes. For instance, in a crowded urban environment, humans can function as good reference objects since they have parallel lines (head to toe or head-toe lines) when standing upright.

Using humans as reference objects to calibrate a camera has technical problems that result in calibration errors. For example, calibration errors occur from tilted lines (with respect to the ground) when humans do not stand upright. As another example, calibration errors occur from varying human heights that lead to difficulties in considering humans as a reference to measure physical measurements. As yet another example, lines are often only concentrated in some parts of the ground or image.

Example embodiments solve these problems when using humans as reference objects to calibrate a camera. For instance, an example embodiment selects human lines that are orthogonal to the ground, models human heights, and spatially clusters human lines. In one example embodiment, six lines representing the various sub-regions in the ground are sufficient to perform camera calibration. Such example embodiments provide accurate camera calibration that is less prone to error when compared to conventional techniques.

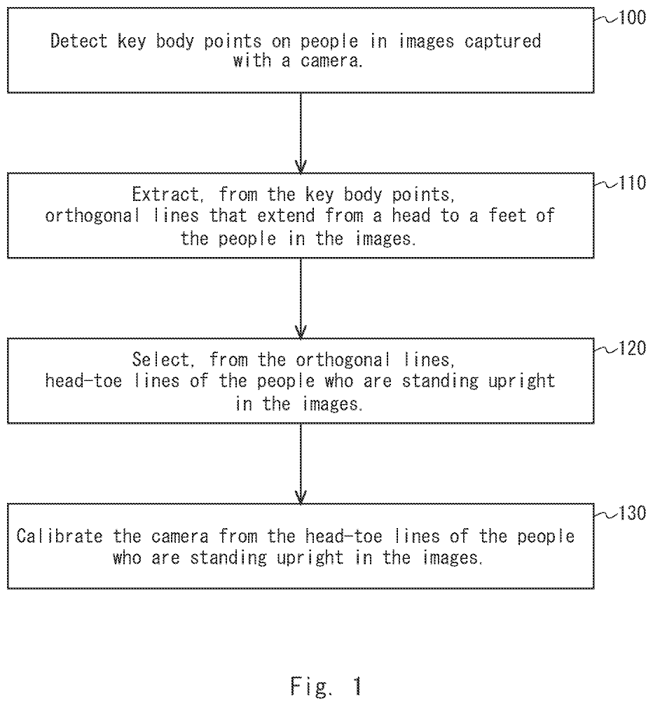

FIG. 1 is a method to calibrate a camera from people in images in accordance with an example embodiment.

The camera captures one or more images that include one or more people. Cameras include electronic devices that record or capture images that may be stored locally and/or transmitted. Images can be individual (e.g., a single photograph) or a sequence of images (e.g., a video or multiple images). Cameras can be located with or part of other electronic devices, such as a camera in a smartphone, laptop computer, tablet computer, wearable electronic device, etc.

Block 100 states detect key body points on people in images captured with a camera.

Key body points include, but are not limited to, one or more of a head, eye(s), ear(s), nose, mouth, chin, neck, torso, shoulder(s), elbow(s), wrist(s), hand(s), hip(s), knee(s), ankle(s), or foot (feet). Key body points also include major or key joints connecting limbs (e.g., ankle, knee, hip, shoulder, elbow, wrist, and neck).

Images can be analyzed to detect objects, such as people. For example, facial recognition software and/or object recognition software detects and identifies one or more key body points on one or more people in the one or more images.

Block 110 states extract, from the key body points, orthogonal lines that extend from a head to a feet of the people in the images.

Once the head and the feet (if observable in the image) are identified, an example embodiment draws or determines a line that extends from the head to the feet of the person. For example, for a person standing or a person straight upright, this line extends from the top of the head, thru the nose and mouth, thru the middle of the neck and torso, and to the ground. If the person is standing upright with both feet together or slightly apart, then this line extends an equal distance between the two feet on the ground.

In an example embodiment, a line drawn from the head to the toe or toe to the head provides an orthogonal line. Body key points can give more accurate orthogonal lines since the neck point is more robust than head position against head movements.

Block 120 states select, from the orthogonal lines, head-toe lines of the people who are standing upright in the images.

A person standing upright generally is standing with a straight back and neck without bending at the hips or knees. For example, a person stands in an upright position in order to obtain an accurate measurement of his or her height. People standing in an upright position generally stand perpendicular to the ground.

Not all head-toe lines represent a person who is standing upright. Head-toe lines are not necessarily perpendicular to the ground on which the person stands. In such cases, the lines can be skewed, slanted, bent, or even horizontal. These lines cause problems when calibrating the camera and, in an example embodiment, are filtered, deleted, or discarded from consideration in the calibration process.

Consider an example in which a person is lying on the ground. In this case, the head-toe line would be parallel or generally parallel to the ground. Consider another example in which the person is standing but bent at the hips or standing with a head tilted. In these cases, the head-toe lines would not be perpendicular to the ground (or surface on which the person is standing), but would be angled. Such head-toe lines can provide inaccurate information regarding sizes or heights of surrounding objects in the image and hence are not reliable for camera calibration.

In an example embodiment, camera calibration is based on head-toe lines of people who are standing upright in the one or more images. These head-toe lines provide a more reliable indication of height and perspective in the image from which the camera can be calibrated. These lines are perpendicular to the ground. Head-toe lines of individuals that are not upright can be deleted, not considered, or provided less weight than those who are standing upright.

Selecting or determining which head-toe lines to accept and which head-toe lines to reject for camera calibration provide various technical challenges. For example, it is difficult to determine accurate orientation of a person in an image. For instance, the person may be standing while being bent at the hip or standing with a tilted neck. Additionally, one or more objects may be blocking a full or partial view of the person (e.g., the person is standing in front of a chair or other object that blocks his or her feet).

Thus, example embodiments select head-toe lines that will provide reliable and accurate information as to size and/or height for camera calibration. In order to make this selection, example embodiments execute and/or consider one or more factors of spatial clustering, pose estimation, head and toe point detection, and human height measurement. These factors are more fully discussed below and reduce errors in using images of people to calibrate a camera.

Spatial clustering is a process of grouping objects with certain dimensions or characteristics into groups (or clusters) such that objects within a same group exhibit similar characteristics when compared to other objects in that same group. Generally, objects in a cluster show a high degree of similarity when compared with objects in other clusters. Outliers are data points that are far away from the mean or median in points in the data set.

Spatial clustering clusters data points, and different clustering algorithms can be executed to define the clusters, such as algorithms based on hierarchical clustering, partial clustering (e.g., K-means), density-based clustering, and grid-based clustering. For example, the distance between the head-toe lines are used for clustering.

Consider an example embodiment that executes K-means clustering. K-means clustering partitions n observations in k clusters. Each observation is assigned to the cluster with the nearest mean. Various algorithms can execute K-means clustering, such as heuristic algorithms or algorithms executing Gaussian distributions with an iterative refinement approach.

Consider an example embodiment where k is an arbitrary number of clusters and is performed based on the toe point of the head-toe lines selected. This process executes to find clusters in every sub-region of the ground plane on which the individuals are standing. Optionally, if one or several of the spatial clusters is sparse in the number of samples, the orthogonal line extraction stage will be prolonged to collect more samples in those sparse sub-regions.

Here, the toe points of the head-toe lines form the population to perform the spatial clustering. As described above, the clustering is performed and the toe-points closest to the cluster centers are selected (in each cluster). The head-toe lines corresponding to these selected toe points are then passed to calibration. In one example embodiment, for a successful calibration, a minimum of six head-toe lines are required across the different sub-regions in the image. Hence, a default number of clusters is defined to be six, to identify six head-toe lines. The user can also set a higher value.

Pose estimation examines the various lines and/or angles between one or more of the key body points. The angles, for example, provide information that can be analyzed to determine the posture of the person (e.g., sitting, standing, lying, standing upright, standing non-upright, etc.).

Consider an example embodiment that considers the angle between certain limbs (e.g., thigh and the upper body). Based on these angles, an example embodiment detects whether a person is sitting or standing. Head-toe lines of humans who are standing alone can be selected using this stage.

Consider an example embodiment that determines a distance or spatial relation between two feet of a standing individual. When the pair-wise distance of ankle key points are checked and determined to be zero or near zero (e.g., the person is standing with his or her feet together or nearly together), then this stance indicates the person is standing and maybe upright. People who are standing with their feet spread too far apart would not have a head-toe line indicative of their true height.

Human poses can be estimated by monitoring the angles between limb key points. For example, the angle between the thigh bone and lower part of the leg is almost 180° for a person who is not bending is knee. Similarly, the angle between thigh bone and the torso is close to 180° for a person who is not bending down.

Head and toe point detection is based on human anatomy proportions. While humans vary in size and shape, human body proportions occur within a standard or known range. In such measurements, the head is a basic unit of measurement and occurs from the top of the head to the chin.

One example embodiment examines the body key point of the neck to determine the probable upright head position. This ensures that head-toe line samples can be extracted from cases where the person is tilting his or her head. Human anatomy ratio principles are used to derive this point from the neck point (e.g., the head position is 1.25 heads away from the neck position).

One example embodiment examines the body key point of the ankle to determine the probable toe position. Similar anatomy ratio principles are utilized to derive this point from the ankle point (e.g., the toe position is 0.25 heads away from the ankle position). The equidistant point between the two toe positions is selected as the human toe center position.

Once the head and toes are located, the height of the person can be determined. The height of the humans are measured by the distance between the top of the head and the toe point.

The height of person in cm is different for each person. So, average human height in cm can be adopted from detailed height surveys performed for the different cases mentioned above and equated to the pixel height in the image. Average height survey is different for different races, different gender and different age groups.

In each cluster, pixel height is calculated via statistical averaging. When the actual human height is not available, an average human height can be used. This height is calculated based on the orthogonal lines extracted from the image(s).

The entire range of human height cannot be used as certain heights may not occur often and should be considered as outliers (e.g., some people are extremely tall and others are extremely short relative to the general population). Hence, a Gaussian fitting of the human heights is performed. The Gaussian mean which represents ±σ is considered as the average human height and the corresponding head-toe line is selected. A Gaussian fitting ensures that the most commonly occurring height measurements are selected for processing.

Heights of different gender and age groups vary considerably and hence age estimation, gender estimation using image processing and/or human anatomy proportion are performed to separate the different groups. For example, a grown adult's height is 8 times his head size, while a baby's height is 4 times its head size.

Block 130 states calibrate the camera from the head-toe lines of the people who are standing upright in the images.

Camera calibration is performed to estimate the camera intrinsic parameters such as focal length, principal point and external parameters such as camera tilt angle, rotation angle and pan angle. In calibration, the selected head-toe lines are used to construct multiple two dimensional planes, which are then used to estimate a minimum of two orthogonal vanishing points and the horizon line. Vanishing points are two dimensional points where edges in an image intersect. The projection matrix is calculated from the vanishing points to estimate the above mentioned camera parameters.

Consider an example embodiment in which a camera takes one or more images and the camera (or another electronic device in communication with the camera) executes camera calibration. Orthogonal lines are spatially sampled with heights. For example, about six points (representing six head-toe lines) are sufficient to calibrate the camera over a camera view. Cluster points occur in six areas over a camera view for six sample points.

Consider an example embodiment that executes temporal sampling. Statistically, averaging heights of many people over a long period of time converges to a statistical measure of human height. Further, taking an average of human heights of a same location can be used as a sampling data. Averaging with each classified person attribute such as gender (male and female) and age (adult, child) can give more accurate sample data.

Consider an example calibration technique that uses a conventional blob approach. This approach extracts the human height line as orthogonal lines by detecting the major axis of the human blob (foreground region detected by applying image differencing/background subtraction). The problem is that when people are together the major axis may be horizontal and thus not represent the human height line as measured from the ground upward. This will not happen with example embodiments that do not utilize the conventional blob approach.

Example embodiments also account for occurrences of missing key point estimation data. There might be cases when some of the key points might be not detected because of objects obstructing the person. For example, legs of the person are not visible in the image since they are being obstructed by a chair or other object. An example embodiment solves this problem by using human anatomy proportions to estimate such missing key points.

Conventional pose estimation techniques for camera calibration extract human height lines irrespective of whether a person is standing or sitting or bending. Selecting such lines is not desirable and affects the accuracy of the camera calibration. An example embodiment solves this problem by monitoring or determining the angles between human limbs (generated by drawing lines between the key body points). For example, the angles between the torso and the legs are monitored to find whether a person is bending down or not.

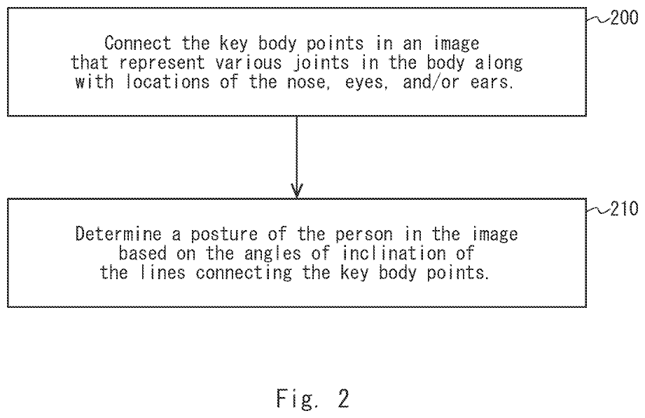

FIG. 2 is a method to determine a posture of a person in an image in accordance with an example embodiment.

Block 200 states connect key body points in an image that represent various joints in the body along with locations of the nose, eyes, and/or ears.

One or more lines are drawn between key body points. By way of example, these lines include, but are not limited to, one or more of lines between the wrist and elbow, the elbow and the shoulder, the neck and the hip, the hip and knee, the knee and the ankle, the shoulder and the neck, the neck and the chin or mouth or nose, and the eyes and the ears.

Block 210 states determine a posture of the person in the image based on the angles of inclination of the lines connecting the key body points.

Human poses can be estimated by monitoring the angles between limb key points. For example, the angle between the thigh bone and lower part of the leg is almost 180° for a person who is not bending is knee. Similarly, the angle between thigh bone and the torso is close to 180° for a person who is not bending down.

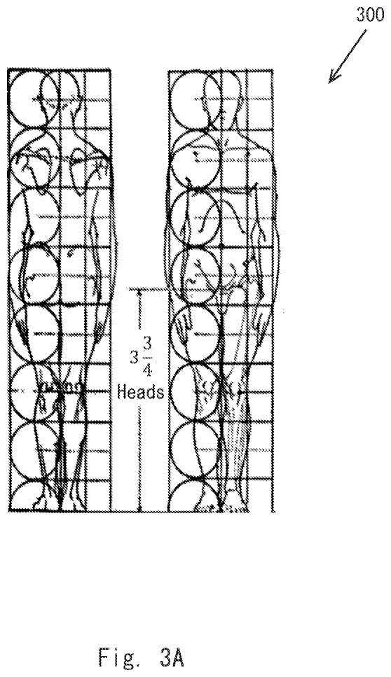

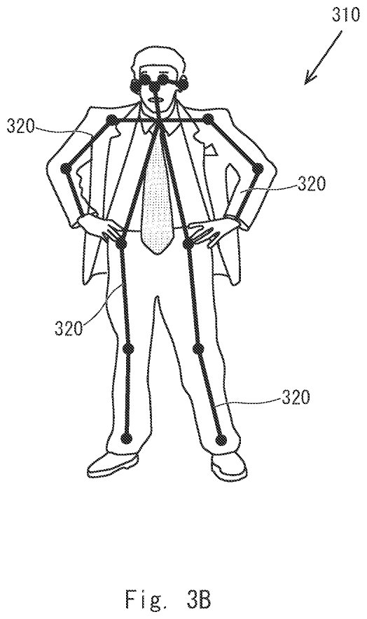

FIG. 3A shows a front and back side view of a human 300 with key body points (shown with circles) in accordance with an example embodiment.

FIG. 3B shows a front view of a human 310 with lines 320 connecting key body points in accordance with an example embodiment. Joints are located at points where two lines meet and are shown with a black dot.

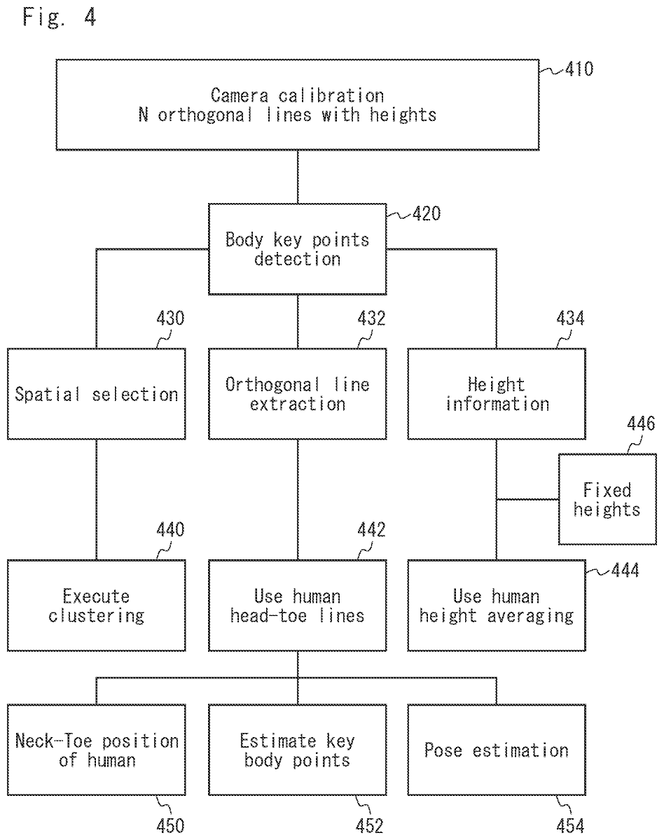

FIG. 4 is a flow diagram for calibrating a camera based on analysis of images of people in accordance with an example embodiment.

The flow diagram starts at block 410 (camera calibration of N orthogonal lines with heights) and proceeds to block 420 (body key points detection). Block 420 couples to three blocks: 430 (spatial selection), 432 (orthogonal line extraction), and 434 (height information). Block 446 (fixed heights) and block 444 (use human height averaging, such as gender, age, etc.) couple to block 434. Block 442 couples to three blocks: 450 (neck-toe position of human), 452 (estimate key body points, such as toe/feet, head, ankle, ears, etc.), and 454 (pose estimation, such as sitting, standing upright, standing non-upright, lying, etc.).

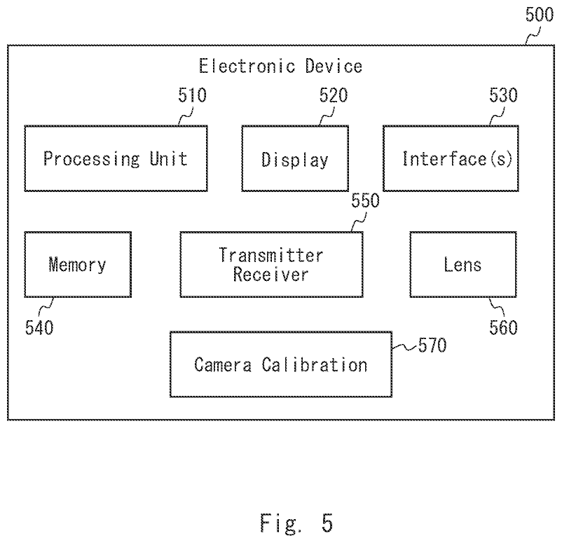

FIG. 5 is an electronic device 500 for executing example embodiments in accordance with an example embodiment.

The electronic device 500 includes one or more of a processing unit 510 (e.g., a processor, controller, microprocessor), a display 520, one or more interfaces 530 (e.g., a user interface or graphical user interface), memory 540 (e.g., RAM and/or ROM), a transmitter and/or receiver 550, a lens 560, and camera calibration 570 (e.g., software and/or hardware that executes one or more blocks or example embodiments discussed herein).

Example embodiments are discussed in connection with using humans as the object to calibrate a camera. Example embodiments, however, are not limited to humans, but can include other objects, such as automobiles, animals, buildings, and other objects and structures.

In some example embodiments, the methods illustrated herein and data and instructions associated therewith, are stored in respective storage devices that are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to a manufactured single component or multiple components.

Blocks and/or methods discussed herein can be executed and/or made by a software application, an electronic device, a computer, firmware, hardware, a process, a computer system, and/or an engine (which is hardware and/or software programmed and/or configured to execute one or more example embodiments or portions of an example embodiment). Furthermore, blocks and/or methods discussed herein can be executed automatically with or without instruction from a user.

While exemplary embodiments have been presented in the foregoing detailed description of the present embodiments, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing exemplary embodiments of the invention, it being understood that various changes may be made in the function and arrangement of steps and method of operation described in the exemplary embodiments without departing from the scope of the invention as set forth in the appended claims.

For example, the whole or part of the exemplary embodiments disclosed above can be described as, but not limited to, the following supplementary notes.

(Supplementary Note 1)

A method executed by one or more processors to improve calibration of a camera, comprising:

detecting, from images captured with the camera, key body points on people in the images;

extracting, from the key body points, orthogonal lines with heights that extend from a head point to a center point of toes of the people;

selecting, from the orthogonal lines with heights, head-toe lines of the people who are standing upright in the images; and

calibrating the camera from the orthogonal lines with heights.

(Supplementary Note 2)

The method of note 1 further comprising:

executing spatial clustering based on a toe point of the head-toe lines to find clusters in every sub-region on a ground plane where the people in the images are standing.

(Supplementary Note 3)

The method of note 2 further comprising:

when one or more spatial clusters is sparse in sub-regions of the images, then collecting and analyzing more orthogonal lines in the sub-regions.

(Supplementary Note 4)

The method of note 1 further comprising:

determining the people who are standing upright by determining angles between a thigh and an upper body of the people and the thigh and lower part of a leg of the people.

(Supplementary Note 5)

The method of note 1 further comprising:

determining a distance between ankles of people as one of the key body points to identify people who are standing with feet together; removing, from the calibrating step and based on the distance between ankles, people who are standing upright but whose feet are not together; and

adding, to the calibrating step and based on the distance between ankles, people who are standing upright and whose feet are together.

(Supplementary Note 6)

The method of note 1 further comprising:

determining a tilt of heads of the people based on a neck point as one of the key body points;

removing, from the calibrating step and based on the tilt of heads of the people, people who are standing upright but whose heads are tilted; and

adding, to the calibrating step and based on the tilt of heads of the people, people who are standing upright but whose heads are not tilted.

(Supplementary Note 7)

The method of note 1 further comprising:

determining a tilt of heads of the people based on a neck point as one of the key body points;

removing, from the calibrating step and based on the tilt of heads of the people, people who are standing upright but whose heads are tilted; and

adding, to the calibrating step and based on the tilt of heads of the people, people who are standing upright but whose heads are not tilted.

(Supplementary Note 8) The method of note 1 further comprising:

calculating, based on a statistical mean of heights of the orthogonal lines extracted from the images, an average human height of the people in the images; and

removing, from the calibrating step, heights of the orthogonal lines that are outliers per the average human height.

(Supplementary Note 9)

A camera, comprising:

a lens that captures images with people;

a memory that stores instructions; and

a processor that executes the instructions to improve calibration of the camera by:

detecting, from the images, key body points on the people;

extracting, from the key body points, orthogonal lines that extend from a head to feet of the people;

selecting, from the orthogonal lines, head-toe lines of the people who are standing upright in the images; and

calibrating the camera from the head-toe lines of the people who are standing upright in the images.

(Supplementary Note 10)

The camera of note 9, wherein the processor further executes the instructions to improve calibration of the camera by:

removing, from the step of calibrating the camera, the head-toe lines of the people who are not standing upright in the images.

(Supplementary Note 11)

The camera of note 9, wherein the processor further executes the instructions to improve calibration of the camera by:

spatially clustering the head-toe lines to represent various sub-regions on a ground in the images.

(Supplementary Note 12)

The camera of note 9, wherein the processor further executes the instructions to improve calibration of the camera by:

modeling human heights per a Gaussian fitting to select the head-toe lines having an average human height.

(Supplementary Note 13)

The camera of note 9, wherein the key points on the people include a head point, a neck point, a shoulder point, an elbow point, a wrist point, a hip point, a knee point, and an ankle point.

(Supplementary Note 14)

The camera of note 9, wherein the processor further executes the instructions to improve calibration of the camera by:

finding postures of the people by determining angles of inclination of lines connecting the key body points.

(Supplementary Note 15)

The camera of note 9, wherein the processor further executes the instructions to improve calibration of the camera by:

connecting the key body points to find joints in the people along with nose, eyes, and ear positions; and

finding postures of the people based on locations of the joints, the nose, the eyes, and the ears.

(Supplementary Note 16)

The camera of note 9, wherein the processor further executes the instructions to improve calibration of the camera by:

determining an absence of key body points to indicate that certain body parts are not visible from a point-of-view of the lens of the camera.

(Supplementary Note 17)

A non-tangible computer readable storage medium storing instructions that one or more electronic devices execute to perform a method that improves calibration of a camera, the method comprising:

detecting key body points on people in images;

extracting, from the key body points, orthogonal lines that extend from a head to feet of the people;

selecting, from the orthogonal lines, head-toe lines of the people who are standing upright in the images; and

calibrating the camera from the head-toe lines of the people who are standing upright in the images.

(Supplementary Note 18)

The non-tangible computer readable storage medium of note 17 in which the method further comprises:

determining, from the key body points, a head and toes of the people; and

providing the head-toe lines to extend from the head to the toes of the people.

(Supplementary Note 19)

The non-tangible computer readable storage medium of note 17 in which the method further comprises:

determining, from the key body points, angles of lines extending between one or more of knees, ankles, hips, neck, and head of the people; and

determining, from the angles, which of the people are sitting, which of the people are standing in a non-upright position, and which of the people are standing in an upright position.

(Supplementary Note 20)

The non-tangible computer readable storage medium of note 17 in which the method further comprises:

removing, from the step of calibrating the camera, the head-toe lines of the people who are not standing upright in the images.

This application is based upon and claims the benefit of priority from Singapore Patent Application No. 10201809572R, filed on Oct. 29, 2018, the disclosure of which is incorporated herein in its entirety by reference.

### REFERENCE SIGNS LIST

300 Human
310 Human
320 Line
500 Electronic Device
510 Processing Unit
520 Display
530 Interface(s)
540 Memory
550 Receiver
560 Lens
570 Camera Calibration

1. A method executed by one or more processors to improve calibration of a camera, comprising:
detecting, from images captured with the camera, key body points on people in the images;
extracting, from the key body points, orthogonal lines with heights that extend from a head point to a center point of toes of the people;
selecting, from the orthogonal lines with heights, head-toe lines of the people who are standing upright in the images; and
calibrating the camera from the orthogonal lines with heights.

2. The method of claim 1 further comprising:
executing spatial clustering based on a toe point of the head-toe lines to find clusters in every sub-region on a ground plane where the people in the images are standing.

3. The method of claim 2 further comprising:
when one or more spatial clusters is sparse in sub-regions of the images, then collecting and analyzing more orthogonal lines in the sub-regions.

4. The method of claim 1 further comprising:
determining the people who are standing upright by determining angles between a thigh and an upper body of the people and the thigh and lower part of a leg of the people.

5. The method of claim 1 further comprising:
determining a distance between ankles of people as one of the key body points to identify people who are standing with feet together;
removing, from the calibrating step and based on the distance between ankles, people who are standing upright but whose feet are not together; and
adding, to the calibrating step and based on the distance between ankles, people who are standing upright and whose feet are together.

6. The method of claim 1 further comprising:
determining a tilt of heads of the people based on a neck point as one of the key body points;
removing, from the calibrating step and based on the tilt of heads of the people, people who are standing upright but whose heads are tilted; and
adding, to the calibrating step and based on the tilt of heads of the people, people who are standing upright but whose heads are not tilted.

7. The method of claim 1 further comprising:
determining a tilt of heads of the people based on a neck point as one of the key body points;
removing, from the calibrating step and based on the tilt of heads of the people, people who are standing upright but whose heads are tilted; and
adding, to the calibrating step and based on the tilt of heads of the people, people who are standing upright but whose heads are not tilted.

8. The method of claim 1 further comprising:
calculating, based on a statistical mean of heights of the orthogonal lines extracted from the images, an average human height of the people in the images; and
removing, from the calibrating step, heights of the orthogonal lines that are outliers per the average human height.

9. A camera, comprising:
a lens that captures images with people;
a memory that stores instructions; and
a processor that executes the instructions to improve calibration of the camera by:
detecting, from the images, key body points on the people;
extracting, from the key body points, orthogonal lines that extend from a head to feet of the people;
selecting, from the orthogonal lines, head-toe lines of the people who are standing upright in the images; and
calibrating the camera from the head-toe lines of the people who are standing upright in the images.

10. The camera of claim 9, wherein the processor further executes the instructions to improve calibration of the camera by:
removing, from the step of calibrating the camera, the head-toe lines of the people who are not standing upright in the images.

11. The camera of claim 9, wherein the processor further executes the instructions to improve calibration of the camera by:
spatially clustering the head-toe lines to represent various sub-regions on a ground in the images.

12. The camera of claim 9, wherein the processor further executes the instructions to improve calibration of the camera by:
modeling human heights per a Gaussian fitting to select the head-toe lines having an average human height.

13. The camera of claim 9, wherein the key points on the people include a head point, a neck point, a shoulder point, an elbow point, a wrist point, a hip point, a knee point, and an ankle point.

14. The camera of claim 9, wherein the processor further executes the instructions to improve calibration of the camera by:
finding postures of the people by determining angles of inclination of lines connecting the key body points.

15. The camera of claim 9, wherein the processor further executes the instructions to improve calibration of the camera by:
connecting the key body points to find joints in the people along with nose, eyes, and ear positions; and
finding postures of the people based on locations of the joints, the nose, the eyes, and the ears.

16. The camera of claim 9, wherein the processor further executes the instructions to improve calibration of the camera by:
determining an absence of key body points to indicate that certain body parts are not visible from a point-of-view of the lens of the camera.

17. A non-tangible computer readable storage medium storing instructions that one or more electronic devices execute to perform a method that improves calibration of a camera, the method comprising:
detecting key body points on people in images;
extracting, from the key body points, orthogonal lines that extend from a head to feet of the people;
selecting, from the orthogonal lines, head-toe lines of the people who are standing upright in the images; and
calibrating the camera from the head-toe lines of the people who are standing upright in the images.

18. The non-tangible computer readable storage medium of claim 17 in which the method further comprises:
determining, from the key body points, a head and toes of the people; and
providing the head-toe lines to extend from the head to the toes of the people.

19. The non-tangible computer readable storage medium of claim 17 in which the method further comprises:
determining, from the key body points, angles of lines extending between one or more of knees, ankles, hips, neck, and head of the people; and
determining, from the angles, which of the people are sitting, which of the people are standing in a non-upright position, and which of the people are standing in an upright position.

20. The non-tangible computer readable storage medium of claim 17 in which the method further comprises:
removing, from the step of calibrating the camera, the head-toe lines of the people who are not standing upright in the images.
